(19) United States
(12) Patent Application Publication
(10) Pub. No.: US 2022/0146249 A1
(43) Pub. Date: May 12, 2022

(54) GRATING DISPLACEMENT MEASURING DEVICE AND METHOD BASED ON CONICAL DIFFRACTION

(71) Applicant: Changchun Institute of Optics, Fine Mechanics and Physics, Chinese Academy of Sciences, Changchun (CN)

(72) Inventors: Wenhao LI, Changchun (CN); Zhaowu LIU, Changchun (CN); Wei WANG, Changchun (CN); Lin LIU, Changchun (CN); Shan JIANG, Changchun (CN); Hongzhu YU, Changchun (CN); Yanxiu JIANG, Changchun (CN)

(21) Appl. No.: 17/583,162

(22) Filed: Jan. 24, 2022

(30) Foreign Application Priority Data
Sep. 18, 2021 (CN) 202111104433.8

(51) Int. Cl. G01B 11/02; G02B 27/28; G02B 5/18

(52) U.S. Cl. CPC G01B 11/026; G02B 5/18; G02B 27/283

(57) ABSTRACT

A grating displacement measuring device based on conical diffraction, including a laser diode configured to emit a measuring beam, a collimating lens, a polarizing beam splitter, a first reflecting mirror, a second reflecting mirror, a third reflecting mirror, a fourth reflecting mirror and a phase shift measuring unit. A grating displacement measuring method based on conical diffraction is also provided.

### CROSS-REFERENCE TO RELATED APPLICATIONS

This application claims the benefit of priority from Chinese Patent Application No. 202111104433.8, filed on Sep. 18, 2021. The content of the aforementioned application, including any intervening amendments thereto, is incorporated herein by reference in its entirety.

### TECHNICAL FIELD

This application relates to precise displacement measurement, and more particularly to a grating displacement measuring device and method based on conical diffraction.

### BACKGROUND

The grating displacement measurement system employs a grating as a measuring ruler and the grating pitch as the measurement benchmark. Compared with laser measurement, the grating measurement is less sensitive to environmental changes, and the beam incident on the grating will cover a large number of grooves to be averagely split. In addition, the reading head of the grating displacement measurement system has a simple and compact structure, and a distance between the grating and the reading head is small and will not increase with the increase of the distance to be measured, such that the environmental effect on the measurement accuracy is largely weakened, and the measuring cost is also reduced. The improvement of grating manufacturing level has brought elevated the measurement accuracy and resolution of the grating displacement measurement system, and expanding the application range.

The phase shift measurement units of the existing grating displacement measurement systems generally share the same optical path arrangement and working principle. Specifically, a photodiode is usually used to receive different interference signals, and the displacement of the grating to be measured is calculated according to the interference signals. Whereas the existing displacement measurement systems vary significantly in the design of the front optical path into the phase shift measurement unit, and the different front optical path designs will also cause different errors of the grating displacement measurement system.

The grating displacement measurement system generally suffers a linear geometric error and a non-linear error caused by various factors. Unfortunately, the nonlinear error has still not been fully investigated, and considering that there are a large number of polarization optical components in the displacement measurement system, it fails to effectively ensure a desired processing and assembly accuracy. During the propagation process in an optical system, the measurement signal, under the influence of the polarizing beam splitter, quarter-wave plate and grating, will experience a change in the polarization characteristics and phase. After the measurement signal passes through the quarter-wave plate many times, the processing and installation angle errors of the optical axis of the quarter-wave plates will lead to non-linear errors when the measurement signal interferes at the receiver, affecting the final measurement result. Therefore, the grating displacement measurement device is required to simultaneously have functions of phase acquisition and polarization modulation, and the use of the quarter-wave plate in the grating displacement measurement device should be minimized to reduce the nonlinear errors caused by the quarter-wave plate.

### SUMMARY

An objective of the present disclosure is to provide a grating displacement measuring device and method based on conical diffraction to overcome the defects in the prior art.

The technical solutions of the present disclosure are described as follows.

In a first aspect, the present disclosure provides a grating displacement measuring device based on conical diffraction, comprising:

a laser diode configured to emit a measuring beam;

a collimating lens;

a polarizing beam splitter;

a first reflecting mirror;

a second reflecting mirror;

a third reflecting mirror;

a fourth reflecting mirror; and

a phase shift measuring unit;

wherein the collimating lens is configured to collimate the measuring beam; the measuring beam is configured to be collimated by the collimating lens and enter the polarizing beam splitter in a conical incident state; and the polarizing beam splitter is configured to split the measuring beam into a first measuring beam in an S-polarization state and a second measuring beam in a P-polarization state;

after being reflected by the polarizing beam splitter, the first measuring beam is reflected by the first reflecting mirror to travel to a surface of a grating to be measured; the first measuring beam is diffracted by the grating to be measured into a first 0th-order diffraction light and a first first-order diffraction light; the first 0th-order diffraction light exits the grating displacement measuring device; the first first-order diffraction light is perpendicularly incident on the third reflecting mirror, and then is reflected by the third reflecting mirror back to the surface of the grating to be measured; and the first first-order diffraction light travels reversely along an optical path of the first measuring beam, and is reflected by the first reflecting mirror to be incident on the polarizing beam splitter, transmitted by the polarizing beam splitter to convert into a P-polarized light and travels to the phase shift measuring unit;

after being transmitted by the polarizing beam splitter, the second measuring beam is reflected by the second reflecting mirror to be incident on the surface of the grating to be measured; the second measuring beam is diffracted by the grating to be measured into a second 0th-order diffraction light and a second first-order diffraction light; the second 0th-order diffraction light exits the grating displacement measuring device; the second first-order diffraction light is perpendicularly incident on the fourth reflecting mirror, and then is reflected by the fourth reflecting mirror back to the surface of the grating to be measured; and the second first-order diffraction light travels reversely along an optical path of the second measuring beam, and is reflected by the second reflecting mirror to be incident on the polarizing beam splitter, reflected by the polarizing beam splitter to convert into an S-polarized light and travels to the phase shift measuring unit; and

the phase shift measuring unit is configured to receive an interference signal of the P-polarized light and an interference signal of the S-polarized light to perform signal processing and calculation to obtain a displacement of the grating to be measured.

In some embodiments, an incident plane of the first measuring beam and an incident plane of the second measuring beam both form an angle with a groove on the surface of the grating to be measured.

In some embodiments, a spot of the first measuring beam on the surface of the grating to be measured is coincided with a spot of the second measuring beam on the surface of the grating to be measured.

In a second aspect, the present disclosure provides a grating displacement measuring method based on conical diffraction, comprising:

(S1) emitting, by the laser diode, a measuring beam; collimating, by the collimating lens, the measuring beam; and allowing a collimated measuring beam to be conically incident on the polarizing beam splitter;

(S2) splitting, by the polarizing beam splitter, the measuring beam into a first measuring beam and a second measuring beam; wherein the first measuring beam is a reflected measuring beam, and is an S-polarized light; and the second measuring beam is a transmitted measuring beam, and is a P-polarized light;

(S3) reflecting, by the first reflecting mirror, the first measuring beam to be incident on the surface of the grating to be measured; and reflecting, by the second reflecting mirror, the second measuring beam to be incident on the surface of the grating to be measured;

(S4) diffracting, by the grating to be measured, the first measuring beam into a first 0th-order diffraction light and a first first-order diffraction light; allowing the first 0th-order diffraction light to exit the grating displacement measuring device; allowing the first first-order diffraction light to perpendicularly travel to the third reflecting mirror and reflecting, by the third reflecting mirror, the first first-order diffraction light back to the surface of the grating to be measured; allowing the first first-order diffraction light to travel in an opposite direction along an optical path of the first measuring beam; reflecting perpendicularly, by the first reflecting mirror, the first first-order diffraction light to be incident on the polarizing beam splitter; transmitting, by the polarizing beam splitter, the first first-order diffraction light to convert the first first-order diffraction light into a P-polarized light; and allowing the P-polarized light to travel to the phase shift measuring unit;

diffracting, by the grating to be measured, the second measuring beam into a second 0th-order diffraction light and a second first-order diffraction light; allowing the second 0th-order diffraction light to exit the grating displacement measuring device; allowing the second first-order diffraction light to perpendicularly travel to the fourth reflecting mirror, and reflecting, by the fourth reflecting mirror, the second first-order diffraction light back to the surface of the grating to be measured; allowing the second first-order diffraction light to travel in an opposite direction along an optical path of the second measuring beam; reflecting perpendicularly, by the second reflecting mirror, the second first-order diffraction light to be incident on the polarizing beam splitter; reflecting, by the polarizing beam splitter, the second first-order diffraction light to convert the second first-order diffraction light into an S-polarized light; and allowing the S-polarized light to travel to the phase shift measuring unit; and

(S5) receiving, by the phase shift measuring unit, an interference signal of the P-polarized light and an interference signal of the S-polarized light to perform signal processing and calculation, so as to obtain a displacement of the grating to be measured.

The beneficial effects of the present disclosure are described as follows.

1. The grating displacement measuring device provided herein optimizes the optical structure according to the principle of conical diffraction by reducing the use of quarter-wave plates, avoiding nonlinear errors caused by the processing and mounting errors of the quarter-wave plate and allowing for a high measurement accuracy.

2. The grating displacement measuring device provided herein includes a reflection device, such that the measuring beam can travel to the grating to be measured again, ensuring an optical subdivision with a higher factor.

### BRIEF DESCRIPTION OF THE DRAWINGS

FIG. 1 schematically depicts a structure of a grating displacement measuring device based on conical diffraction according to an embodiment of the present disclosure;

FIG. 2 schematically depicts diffraction of a first measuring beam on a grating to be measured according to an embodiment of the present disclosure;

FIG. 3 is a perspective view showing relative positions of some components of the grating displacement measuring device according to an embodiment of the present disclosure;

FIG. 4 is a flowchart of a grating displacement measuring method based on conical diffraction according to an embodiment of the present disclosure; and

FIG. 5 schematically depicts a change of a polarization state of a second measuring beam according to an embodiment of the present disclosure.

In the drawings, 1, laser diode; 2, collimating lens; 3, polarizing beam splitter; 5, first reflecting mirror; 6, grating to be measured; 7, second 0th-order diffraction light; 8, first 0th-order diffraction light; 9, second reflecting mirror; 10, third reflecting mirror; 11, fourth reflecting mirror; 13, phase shift measuring unit; 14, first photodiode; 15, second photodiode; 16, third photodiode; 17, fourth photodiode; 18, incident plane; 19, first measuring beam; 20, first first-order diffraction light; 22, P-polarized light; 23, second measuring beam; 24, second first-order diffraction light; 25, half-wave plate; 26, beam splitting prism; 27, quarter-wave plate; 28, first phase-shift polarizing beam splitter; and 29, second phase-shift polarizing beam splitter.

### DETAILED DESCRIPTION OF EMBODIMENTS

The present disclosure will be described below with reference to the accompany drawings and the embodiments, in which the same elements are denoted by the same reference numeral, and the elements with the same reference numerals have the same name and function.

The objectives, technical solutions and beneficial effects of the present disclosure will be described in detail with reference to the accompany drawings and the embodiments. It should be understood that the embodiments provided herein are illustrative of the present disclosure, and not intended to limit the present disclosure.

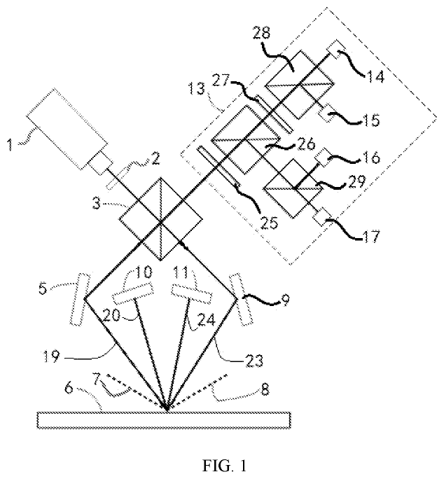

The specific operation of the grating displacement measuring device based on conical diffraction will be described in detail below with reference to FIGS. 1-5.

FIG. 1 shows a specific structure of the grating displacement measuring device.

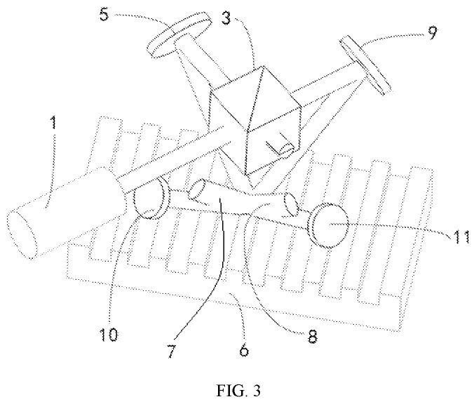

FIG. 3 shows relative spatial positions of some components of the grating displacement measuring device.

As shown in FIGS. 1 and 3, a grating displacement measuring device based on conical diffraction is provided, which includes a laser diode 1, a collimating lens 2, a polarizing beam splitter 3, a first reflecting mirror 5, a second reflecting mirror 9, a third reflecting mirror 10, a fourth reflecting mirror 11 and a phase shift measuring unit 13.

The laser diode 1 is configured to emit a measuring beam and to ensure that the measuring beam is conically emitted to the polarizing beam splitter 3.

The collimating lens 2 is configured to collimate the measuring beam. The collimating lens 2 is arranged between the laser diode 1 and the polarizing beam splitter 3.

The polarizing beam splitter 3 is configured to split the measuring beam into a first measuring beam 19 and a second measuring beam 23.

The measuring beam collimated by the collimating lens 2 enters the polarizing beam splitter 3, and is split by the polarizing beam splitter 3 into the first measuring beam 19 and the second measuring beam 23. The first measuring beam 19 is a reflected measuring beam, and is an S-polarized light. The second measuring beam 23 a transmitted measuring beam, and is a P-polarized light 22.

An incident plane of the first measuring beam 19 and an incident plane of the second measuring beam 23 both form an angle with a groove on a surface of a grating to be measured 6.

In an embodiment, the first measuring beam 19 is reflected by the first reflecting mirror 5 to the grating to be measured 6 at an azimuth angle of 45° and an incident angle of 45°; and the second measuring beam 23 is reflected by the second reflecting mirror 9 to the grating to be measured 6 at an azimuth angle of 45° and an incident angle of 45°.

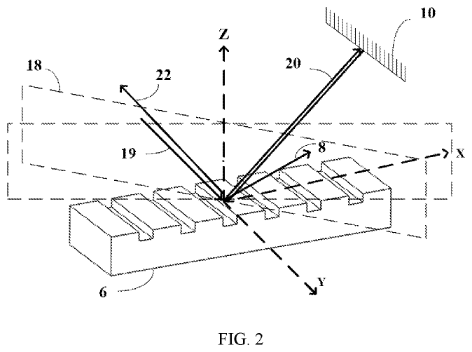

The diffraction optical path of the first measuring beam 19 on the grating to be measured 6 is specifically illustrated in FIG. 2.

As shown in FIG. 2, a spatial rectangular coordinate system is established, in which a spot of the first measuring beam 19 on the surface of the grating to be measured 6 is taken as an origin; a direction perpendicular to the surface of the grating to be measured 6 is taken as a Z axis; a direction, in the surface of the grating to be measured 6, parallel to a direction of the groove on the surface of the grating to be measured 6 is taken as a Y axis; and a direction, in the surface of the grating to be measured 6, perpendicular to the direction of the groove on the surface of the grating to be measured 6 is taken as an X axis.

The first measuring beam 19 is reflected by the first reflecting mirror 5 and then is incident on the surface of the grating to be measured 6. As shown in FIG. 2, the first measuring beam 19 is diffracted by the grating to be measured 6 into a first 0th-order diffraction light 8 and a first first-order diffraction light 20. The first 0th-order diffraction light 8 exits the grating displacement measuring device. The first first-order diffraction light 20 is perpendicularly incident on the third reflecting mirror 10, and then is reflected by the third reflecting mirror 10 back to the surface of the grating to be measured 6. The first first-order diffraction light 20 is then incident on the polarizing beam splitter 3 through the first reflecting mirror 5 according to the optical path of the first measuring beam 19, converted into a P-polarized light 22 through being transmitted by the polarizing beam splitter 3, and travels to the phase shift measuring unit 13.

The second measuring beam 23 is reflected by the second reflecting mirror 9 and is incident on the surface of the grating to be measured 6. The second measuring beam 23 is then diffracted by the grating to be measured 6 into a second 0th-order diffraction light 7 and a second first-order diffraction light 24. The second 0th-order diffraction light 7 exits the grating displacement measuring device. The second first-order diffraction light 24 is perpendicularly incident on the fourth reflecting mirror 11, and then is reflected by the fourth reflecting mirror 11 back to the surface of the grating to be measured 6. The second first-order diffraction light 24 is then incident on the polarizing beam splitter 3 through the second reflecting mirror 9 according to an optical path of the second measuring beam 23, converted into an S-polarized light through being reflected by the polarizing beam splitter 3, and travels to the phase shift measuring unit 13.

The spot of the first measuring beam 19 on the surface of the grating to be measured 6 is coincided with a spot of the second measuring beam 23 on the surface of the grating to be measured 6.

In an embodiment, the measuring beam emitted by the laser diode 1 is a linearly polarized light whose polarization direction is 45° with respect to the Y axis; and an installation angle of a half-wave plate 25 is 22.5° with respect to the Y axis.

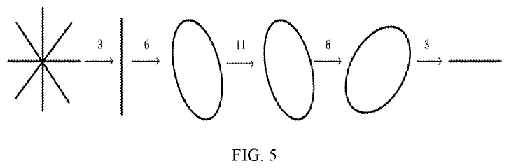

FIG. 5 shows a change of a polarization state of the second measuring beam 23 during the propagation.

As shown in FIG. 5, the laser diode 1 emits a measuring beam of any polarization state, and then the measuring beam is split by the polarizing beam splitter 3 to obtain the second measuring beam 23, which is the P-polarized light 22. The second measuring beam 23 is conically incident on the grating to be measured 6 and converted into an elliptically polarized light, which is then perpendicularly incident on the fourth reflecting mirror 11 without changing the polarization state. After being reflected by the fourth reflecting mirror 11, the second measuring beam is incident on the grating to be measured 6 again, converted into an elliptically polarized light with the other state, and incident on the polarizing beam splitter 3 again. After being split by the polarizing beam splitter 3, the second measuring beam is S-polarized.

Similarly, the laser diode 1 emits a measuring beam of any polarization state, and then the measuring beam is split by the polarizing beam splitter 3 to obtain the first measuring beam 19, which is the S-polarized light. The first measuring beam 19 is conically incident on the grating to be measured 6 and converted into an elliptically polarized light, which is then perpendicularly incident on the third reflecting mirror 10 without changing the polarization state. After being reflected by the third reflecting mirror 10, the first measuring beam is incident on the grating to be measured 6 again, converted into an elliptically polarized light with the other state, and incident on the polarizing beam splitter 3 again. After being split by the polarizing beam splitter 3, the first measuring beam is P-polarized.

According to the rigorous coupled wave theory, when the measuring beam is incident on the grating to be measured 6, analysis of the vector expression form of the diffracted light shows that there are P and S components in the diffracted light, that is, the original linearly polarized light is transformed into elliptically polarized light. When the elliptically polarized light is reflected perpendicularly by the reflecting mirror and returns in the original way, the elliptical polarized light will become a linearly polarized light or an elliptically polarized light. At this time, the grating to be measured 6 works as a quarter-wave plate to module polarization. Therefore, the arrangement of the vertical reflecting mirrors (the third reflecting mirror 10 and the fourth reflecting mirror 11) reduces the use of quarter-wave plates in the grating displacement measuring device.

The phase shift measuring unit 13 is configured to receive an interference signal of the first measuring beam 19 and an interference signal of the second measuring beam 23 to perform signal processing and calculation to obtain a displacement of the grating to be measured 6.

It should be noted that the method and working principle for the phase shift measuring unit 13 to obtain the displacement of the grating to be measured 6 according to different interference signals are in the prior art.

As shown in FIG. 1, in an embodiment, the phase shift measuring unit 13 includes a first photodiode 14, a second photodiode 15, a third photodiode 16, a fourth photodiode 17, the half-wave plate 25, a beam splitting prism 26, a quarter-wave plate 27, a first phase-shift polarizing beam splitter 28 and a second phase-shift polarizing beam splitter 29.

The first measuring beam 19 and the second measuring beam 23 are simultaneously incident on the beam splitting prism 26 through the half-wave plate 25, and the beam splitting prism 26 splits out two beams.

One beam of the two beams travels to the second phase-shift polarizing beam splitter 29 to generate an interference signal with a phase difference of 0° and an interference signal with a phase difference of 180°. The third photodiode 16 is configured to receive the interference signal with the phase difference of 180°, and the fourth photodiode 17 is configured to receive the interference signal with the phase difference of 0°.

The other beam of the two beams travels to the first phase-shift polarizing beam splitter 28 to generate an interference signal with a phase difference of 90° and an interference signal with a phase difference of 270°. The first photodiode 14 is configured to receive the interference signal with the phase difference of 90°, and the second photodiode 15 is configured to receive the interference signal with the phase difference of 270°.

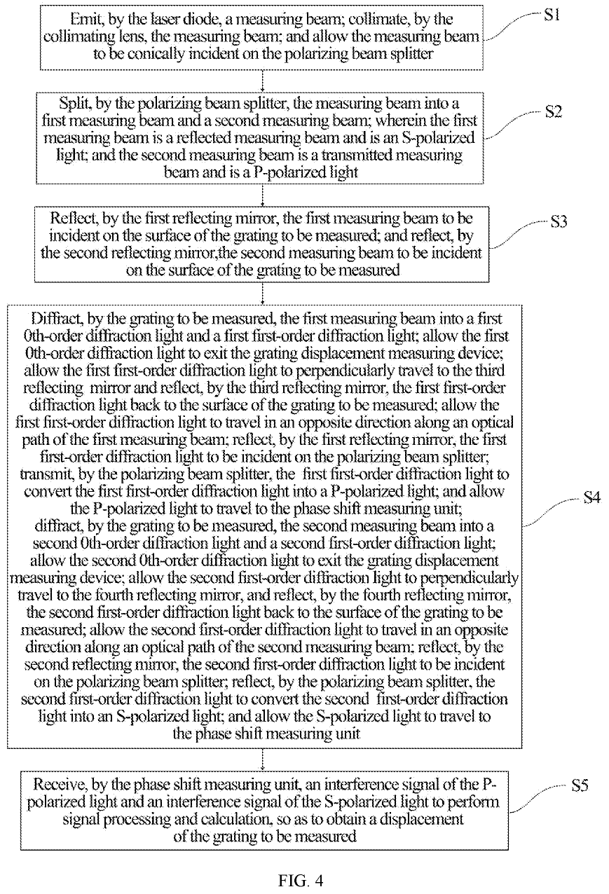

FIG. 4 shows specific steps of a grating displacement measuring method based on conical diffraction.

As shown in FIG. 4, the grating displacement measuring method based on conical diffraction includes the following steps.

(S1) A measuring beam is emitted by the laser diode, collimated by the collimating lens 2 and then conically incident on the polarizing beam splitter 3.

(S2) The measuring beam is split by the polarizing beam splitter 3 into a first measuring beam 19 and a second measuring beam 23. The first measuring beam 19 is a reflected measuring beam, and is an S-polarized light. The second measuring beam 23 a transmitted measuring beam, and is a P-polarized light 22.

(S3) The first measuring beam 19 is reflected by the first reflecting mirror 5 to be incident on the surface of the grating to be measured 6. The second measuring beam 23 is reflected by the second reflecting mirror 9 to be incident on the surface of the grating to be measured 6.

A spot of the first measuring beam 19 on the surface of the grating to be measured 6 is coincided with a spot of the second measuring beam 23 on the surface of the grating to be measured 6.

(S4) The first measuring beam 19 is diffracted by the grating to be measured 6 into a first 0th-order diffraction light 8 and a first first-order diffraction light 20. The first 0th-order diffraction light 8 exits the grating displacement measuring device. The first first-order diffraction light 20 perpendicularly travels to the third reflecting mirror 10, and then is reflected back by the third reflecting mirror 10 to the surface of the grating to be measured 6. The first first-order diffraction light 20 travels reversely along an optical path of the first measuring beam 19, incident on the polarizing beam splitter 3 through the first reflecting mirror 5, transmitted by the polarizing beam splitter 3 to convert into a P-polarized light 22 and travels to the phase shift measuring unit 13.

The second measuring beam 23 is diffracted by the grating to be measured 6 into a second 0th-order diffraction light 7 and a second first-order diffraction light 24. The second 0th-order diffraction light 7 exits the grating displacement measuring device. The second first-order diffraction light 24 perpendicularly travels to the fourth reflecting mirror 11, and then is reflected by the fourth reflecting mirror 11 back to the surface of the grating to be measured 6. The second first-order diffraction light 24 travels reversely along an optical path of the second measuring beam 23, incident on the polarizing beam splitter 3 through the second reflecting mirror 9, reflected by the polarizing beam splitter 3 to convert into an S-polarized light and travels to the phase shift measuring unit 13.

(S5) The phase shift measuring unit 13 receives an interference signal of the first measuring beam 19 and an interference signal of the second measuring beam 23 to perform signal processing and calculation to obtain a displacement of the grating to be measured 6 (prior art).

In summary, a grating displacement measuring device and method for measuring a displacement of a grating based on conical diffraction are provided herein. The grating displacement measuring device optimizes the optical structure according to the principle of conical diffraction by reducing the use of quarter-wave plates, avoiding nonlinear errors caused by the processing and mounting errors of the quarter-wave plate and allowing for a high measurement accuracy. In addition, the grating displacement measuring device provided herein includes a reflection device, such that the measuring beam can travel to the grating to be measured again, ensuring an optical subdivision with a higher factor.

In the description, the structure, material and specific feature described following the terms such as “one embodiment”, “some embodiments” “an example”, “a specific example” and “some examples” are included in at least one of the embodiments or examples of the present disclosure. The structure, material and specific feature may be combined in one or more embodiments and examples. Moreover, the features in various embodiments can be combined as long as there is no contradiction between these features.

It should be understood that the embodiments mentioned above are merely illustrative of the present disclosure, and not intended to limit the present disclosure. Changes, modifications and replacements made by those skilled in the art without departing from the spirit of this disclosure should fall within the scope of the present disclosure defined by the appended claims.

What is claimed is:

1. A grating displacement measuring device based on conical diffraction, comprising:
a laser diode configured to emit a measuring beam;
a collimating lens;
a polarizing beam splitter;
a first reflecting mirror;
a second reflecting mirror;
a third reflecting mirror;
a fourth reflecting mirror; and
a phase shift measuring unit;
wherein the collimating lens is configured to collimate the measuring beam; the measuring beam is configured to be collimated by the collimating lens and enter the polarizing beam splitter in a conical incident state; and the polarizing beam splitter is configured to split the measuring beam into a first measuring beam in an S-polarization state and a second measuring beam in a P-polarization state;
after being reflected by the polarizing beam splitter, the first measuring beam is reflected by the first reflecting mirror to travel to a surface of a grating to be measured;
the first measuring beam is diffracted by the grating to be measured into a first 0th-order diffraction light and a first first-order diffraction light; the first 0th-order diffraction light exits the grating displacement measuring device; the first first-order diffraction light is perpendicularly incident on the third reflecting mirror, and then is reflected by the third reflecting mirror back to the surface of the grating to be measured; and the first first-order diffraction light travels reversely along an optical path of the first measuring beam, and is reflected by the first reflecting mirror to be incident on the polarizing beam splitter, transmitted by the polarizing beam splitter to convert into a P-polarized light and travels to the phase shift measuring unit;
after being transmitted by the polarizing beam splitter, the second measuring beam is reflected by the second reflecting mirror to be incident on the surface of the grating to be measured; the second measuring beam is diffracted by the grating to be measured into a second 0th-order diffraction light and a second first-order diffraction light; the second 0th-order diffraction light exits the grating displacement measuring device; the second first-order diffraction light is perpendicularly incident on the fourth reflecting mirror, and then is reflected by the fourth reflecting mirror back to the surface of the grating to be measured; and the second first-order diffraction light travels reversely along an optical path of the second measuring beam, and is reflected by the second reflecting mirror to be incident on the polarizing beam splitter, reflected by the polarizing beam splitter to convert into an S-polarized light and travels to the phase shift measuring unit; and
the phase shift measuring unit is configured to receive an interference signal of the P-polarized light and an interference signal of the S-polarized light to perform signal processing and calculation to obtain a displacement of the grating to be measured.

2. The grating displacement measuring device of clam 1, wherein an incident plane of the first measuring beam and an incident plane of the second measuring beam both form an angle with a groove on the surface of the grating to be measured.

3. The grating displacement measuring device of claim 1, wherein a spot of the first measuring beam on the surface of the grating to be measured is coincided with a spot of the second measuring beam on the surface of the grating to be measured.

4. A grating displacement measuring method based on conical diffraction using the grating displacement measuring device of claim 1, comprising:
(S1) emitting, by the laser diode, a measuring beam; collimating, by the collimating lens, the measuring beam; and allowing a collimated measuring beam to be conically incident on the polarizing beam splitter;
(S2) splitting, by the polarizing beam splitter, the measuring beam into a first measuring beam and a second measuring beam; wherein the first measuring beam is a reflected measuring beam and is an S-polarized light; and the second measuring beam is a transmitted measuring beam and is a P-polarized light;
(S3) reflecting, by the first reflecting mirror, the first measuring beam to be incident on the surface of the grating to be measured; and reflecting, by the second reflecting mirror, the second measuring beam to be incident on the surface of the grating to be measured;
(S4) diffracting, by the grating to be measured, the first measuring beam into a first 0th-order diffraction light and a first first-order diffraction light; allowing the first 0th-order diffraction light to exit the grating displacement measuring device; allowing the first first-order diffraction light to perpendicularly travel to the third reflecting mirror and reflecting, by the third reflecting mirror, the first first-order diffraction light back to the surface of the grating to be measured; allowing the first first-order diffraction light to travel in an opposite direction along an optical path of the first measuring beam; reflecting, by the first reflecting mirror, the first first-order diffraction light to be incident on the polarizing beam splitter; transmitting, by the polarizing beam splitter, the first first-order diffraction light to convert the first first-order diffraction light into a P-polarized light; and allowing the P-polarized light to travel to the phase shift measuring unit;
diffracting, by the grating to be measured, the second measuring beam into a second 0th-order diffraction light and a second first-order diffraction light; allowing the second 0th-order diffraction light to exit the grating displacement measuring device; allowing the second first-order diffraction light to perpendicularly travel to the fourth reflecting mirror, and reflecting, by the fourth reflecting mirror, the second first-order diffraction light back to the surface of the grating to be measured; allowing the second first-order diffraction light to travel in an opposite direction along an optical path of the second measuring beam; reflecting, by the second reflecting mirror, the second first-order diffraction light to be incident on the polarizing beam splitter; reflecting, by the polarizing beam splitter, the second first-order diffraction light to convert the second first-order diffraction light into an S-polarized light; and allowing the S-polarized light to travel to the phase shift measuring unit; and
(S5) receiving, by the phase shift measuring unit, an interference signal of the P-polarized light and an interference signal of the S-polarized light to perform signal processing and calculation, so as to obtain a displacement of the grating to be measured.
